(19) United States
(12) Patent Application Publication
(10) Pub. No.: US 2013/0076773 A1
(43) Pub. Date: Mar. 28, 2013

(54) NONLINEAR REVISION CONTROL SYSTEM AND METHOD FOR IMAGES

(71) Applicants: Hsiang-Ting CHEN, Hsinchu City (TW); Li-Yi Wei, Redwood City, CA (US); Chun-Fa Chang, Taipei (TW)

(72) Inventors: Hsiang-Ting CHEN, Hsinchu City (TW); Li-Yi Wei, Redwood City, CA (US); Chun-Fa Chang, Taipei (TW)

(73) Assignee: National Tsing Hua University

(21) Appl. No.: 13/241,182

(22) Filed: Sep. 22, 2011

(51) Int. Cl. G06F 17/30; G09G 5/02

(52) U.S. Cl. 345/589; 707/754; 707/E17.059; 707/E17.011

(57) ABSTRACT

A nonlinear revision control system for images is designed with the common digital editing and sketching workflows in mind. DAG (directed acyclic graph) is used as the core structure and DAG nodes represent editing operations, and DAG edges indicate the corresponding spatial, temporal and semantic relationships. DAG is visualized in RevG (revision graph), which provides not only a meaningful display of the revision history, but also an intuitive interface for common revision control operations such as review, replay, diff, addition, branching, merging, and conflict resolving. Beyond revision control, the system also facilitates artistic creation processes in common image editing and digital painting workflows. A prototype system has been built upon GIMP, an open source image editor, and demonstrates its effectiveness through a formative user study and comparisons with alternative revision control systems.

### BACKGROUND OF THE INVENTION

1. Field of the Invention

The invention relates to revision control, more particularly to a nonlinear revision control system and method for images.

2. Description of Related Art

Revision control is an important component of digital content management. Popular revision control systems include CVS, Subversion, and Perforce. By storing file editing histories, revision control systems allow user to revert mistakes and review changes. Revision control systems also facilitate open-ended content creation through mechanisms such as branching and merging. So far, the development and deployment of revision control systems have been focused more on text than binary files. This is understandable, as text files tend to be more frequently used and revised, and it is easier to develop revision control mechanisms for them. (Simple line differencing already provides enough information for text files.) However, in many graphics projects, binary files, such as images, videos, meshes, and animations can be frequently used and revised as well. Here the lack of revision control for binary files could cause several issues. Most existing general purpose revision systems employ a state-based model that stores the different revisions as individual files without any diff/delta information, thus bloating storage space and making it hard to deduce the changes between revisions. Even when deltas (or other low level information like pixel-wise diff) are used, they usually lack sufficient high-level semantic information for reviewing, branching, merging, or visualization. Such high level information can usually be recorded from live user actions with the relevant image editing software. The visualization and interaction design of such user action histories has long been a popular topic. Nevertheless, the lack of a formal representation that depicts the comprehensive relationship (not only temporal but also spatial and semantic) between image editing actions makes these approaches both inefficient and insufficient for revision control.

In view of the drawbacks derived from the conventional packing box, the inventor has tried hard to improve and innovate. After years of painstaking research, the nonlinear revision control system and method for images are proposed in the present invention so as to solve the above-mentioned problems. The present invention is described below.

### SUMMARY OF THE INVENTION

As can be easily understood from the foregoing, the basic concepts of the present invention may be embodied in a variety of ways including various permutations and combinations of the various elements. As such the objects of the invention are similarly numerous and varied. It is therefore, a primary objective of the present invention to provide a nonlinear revision control for images, designed with the common content creation workflows such as digital editing and sketching in mind, maintaining high-level and fine-granularity revision history by recording and consolidating user editing operations. The core idea of the invention is a DAG (directed acyclic graph) data structure representing the nonlinear spatial, temporal, and semantic dependencies between these recorded image editing operations stored as DAG nodes. Such detailed information provides the necessary high level semantics for proper revision control compared to previous works where only low-level bitmap information is used. Built upon the DAG data structure, the primary revision control commands include review, diff, addition, branch, merge, and conflict resolving. All these functionalities are presented through a friendly user interface centered upon RevG (revision graph), which is a multi-resolution graphical revision history representation of the underlying DAG. In addition to core revision control, the invention also facilitates open-ended content creation processes with non-linear editing and exploration.

In order to achieve the above goal, the invention provides a nonlinear revision control system for images, the system includes: a frontend used as an external user interface; a backend coupled to the frontend, wherein the backend further includes: a repository for storing recorded logs and revision control information derived from user editing actions; a first data structure for analyzing and transforming the logs from the repository; a plurality of filters for simplifying the logs from the first data structure; and a second data structure for storing the simplified logs from the plurality of filters and being rendered in the frontend; and an image editor communicated with and applied for the backend.

According to the above purpose, the present invention additionally proposes a nonlinear revision control method for images, the method comprising the steps of: (a) recording editing actions by an image editor; (b) transferring the editing actions as recorded logs from the image editor into a repository; (c) storing the recorded logs in text form in the repository; (d) constructing the text form into a DAG; (e) creating a RevG from the DAG; and (f) showing the RevG at a UI (user interface) frontend.

Preferably, step (e) further includes steps: (e1) dynamically simplifying the DAG into the RevG for proper display; (e2) determining a position, path, shape and color of the nodes of the RevG via a classical hierarchical layout algorithm; and (e3) culling the nodes and edges of the RevG outside a current viewport.

In summary, the present invention has the following contributions:
The idea of a nonlinear revision control system for images.
The core DAG structure representing the revision history, upon which a RevG is built, the multi-resolution revision graph, and various algorithm components for revision control.
A prototype system built with GIMP for practical nonlinear revision control and an intuitive UI centered on RevG for common revision operations including addition, branching, merging, conflict resolving, diff, and non-linear replay.
Additional applications of the present invention such as facilitating open-ended content creation and exploration.

Therefore, the present invention is able to perform nonlinear revision control for images, which not only reduce the storage consumption but also can be convenient for graphics applications, such as images, videos, meshes, and animations, so as to let the user more easily enjoy the graphics, which meets the market demand for image processing.

The invention, as well as its many advantages, may be further understood by the following detailed description and drawings in which:

### BRIEF DESCRIPTION OF THE DRAWINGS

FIG. 1 is a schematic diagram showing the system configuration of one embodiment of the present invention.

FIG. 2 is a system flow diagram of the invention.

Annex 1 is a diagram showing an embodiment of a nonlinear revision control of the present invention, wherein (a) is the input image; (b) is the input image to be cloned twice with translation and perspective deformation; (c) is to modify their colors; (d) is the revision control system to be recorded and analyzed the actions into a DAG data structure; (e) is a graphical revision graph for visualizing the DAG.

Annex 2 is a diagram showing the revision control user interface of an embodiment of the present invention.

Annex 3 is a diagram showing the multi resolution RevG of an embodiment of the present invention, wherein (a) is a coarser resolution and (b) is finer resolution.

Annex 4 is a diagram showing a diff UI of an embodiment of the present invention.

Annex 5 is a diagram showing UI for revision merging of an embodiment of the present invention, wherein: (a) shows a merged UI; (b) is a trunk only; (c) is branch after trunk (d) is branch only.

Annex 6 is a diagram showing a merged image in another embodiment, wherein: (e) is the source image, and (a) to (d) show different combinations of trunk and branch results.

Annex 7 is a diagram showing an image compositing embodiment, wherein: (a) is the image before compositing, (b) is the image after compositing and (c) is a RevG at the finest resolution.

Annex 8 is a diagram showing an image retouching embodiment, wherein: (a) is the image before retouching, (b) is the image after retouching and (c) is a RevG at the finest resolution.

Annex 9 is a diagram showing a digital sketching embodiment, wherein: (a) is a sketch, (b) is a final image and (c) is a RevG at the finest resolution.

Annex 10 is a diagram showing another digital sketching embodiment, wherein: (a) is a sketch, (b) is a final image and (c) is a RevG at the finest resolution.

Annex 11 is a diagram showing a nonlinear exploration, wherein: (a) is a rough selection, (b) is a nonlinear exploration, (c) is another nonlinear exploration, (d) is another rough selection and (e) is a selective undo.

Annex 12 is a diagram showing a revision merge as a creativity support tool, wherein: (a) is an input branch point; (b) and (c) are two different branches created from (a); (d), (e) and (f) are variations created from (a), (b) and (c) images.

### DETAILED DESCRIPTION OF THE INVENTION

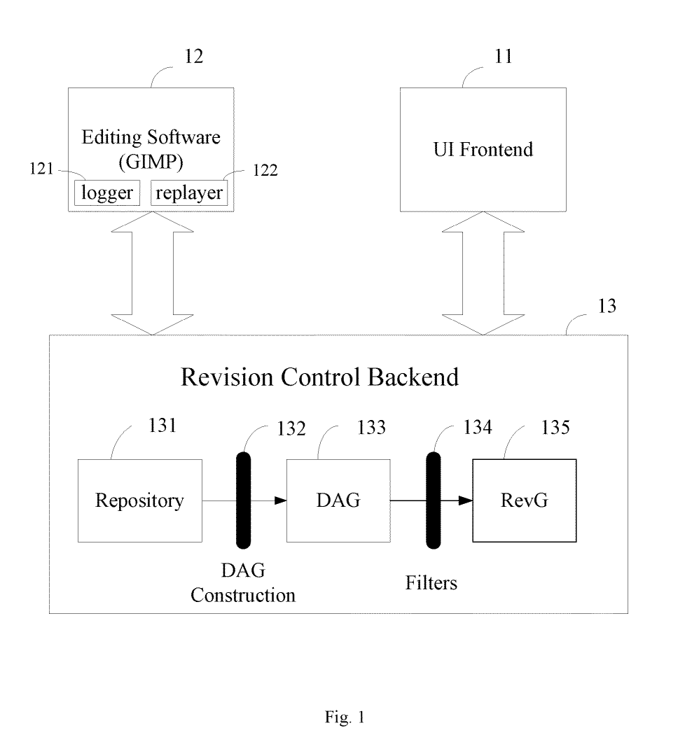

As shown in FIG. 1, which is a schematic diagram showing the system configuration of one embodiment of the present invention, for practical usage and evaluation, the revision control system is fully integrated with GIMP. Referencing the architecture of open source visualization systems, a flexible revision control framework by orthogonalizing the main modules has been built, including: a replaceable UI frontend 11, a replaceable editing software 12 (a GIMP core used in this embodiment), and a revision control backend 13. This design provides flexibility for easy integration with different systems. More specifically, the GIMP core has been modified and two main components have been added: a logger 121 for silently recording user editing actions in the background in the form of text logs and these actions can be replayed in the GIMP via a replayer 122. An action log normally consists of its action name, action parameters, layer ID and a selection mask. For brush and sketching actions, their mouse/stylus motions and pressures are also stored. The revision control backend 13 communicates with GIMP via its official gimplibrary interface. Recorded logs and other revision control information are stored in the repository 131. When a new revision is committed, the corresponding action logs are transferred from GIMP into the repository 131 and then through a DAG construction 132 into the DAG 133. The logs are analyzed and transformed into DAG 133, which are further simplified through various filters 134 into RevG 135. Finally, the RevG 135 is rendered in the frontend renderer 11 based on GTK+.

Therefore, the DAG 133 is built by sequentially inserting each action into the graph with one DAG node corresponding to one action. When inserting a node, the insertion algorithm searches for dependent nodes already in the DAG 133. For orthogonal implementation, the logs are stored in a linear data structure with DAG nodes containing pointers to the corresponding logs.

Accordingly, the DAG 133 records two kinds of dependencies: spatial and semantic. Spatial dependency considers the spatial relationships between operations; they are spatially independent if their regions of operations do not overlap. As for semantic dependency, operations are categorized into five different classes as shown in Table 1 in which the first three rows are semantically independent. Semantically independent operations applied on the same object or regions are put into parallel paths.

TABLE 1

| | |
|---|---|
| rigid transformation (purple) | rotation, translation |
| deformation (brown) | scale, shear, perspective |
| color and filter (green) | hue, saturation, color, balance, |
| | brightness, contrast, gamma, color |
| | fill, blur, sharpen |
| edit (blue) | copy, paste, anchor, add layer, |
| | layer mask |
| brush (golden) | brush, pencil, eraser |

Table 1 shows the supported operations and their classes. Classes in the first three rows are semantic independent. Each font color above indicates border color of a RevG node with the corresponding operation class.

The filters 134 includes a viewport filter for culling RevG nodes/edges outside the current viewport, a layout filter for determining the position, path, shape and color of RevG nodes via the classical hierarchical layout algorithm, and a visual importance filter for dynamically simplifying a DAG into a RevG for proper display. The visual importance filter has two stages. First, it assigns a visual importance value to each DAG node. Second, it filters the DAG into RevG according to the threshold assigned to the current RevG window resolution. The visual importance value v of a DAG node n, which contains one action act(n), is determined by two major factors: image content difference I(n,m) and action context A(n,m). It can be expressed as follows:

$$v ( n ) = \frac{1}{w} {\sum }_{m ∈ N ( n )} I ( n , m ) A ( n , m ) \qquad ( 1 )$$

where m is a neighboring node of n in DAG within distance w, for which 2 is set in this current implementation. Here, I(n,m) is simply the low-level per-pixel difference between the images after applying act(n) and act(m). On the other hand, A(n,m) takes advantage of the high-level information recorded in the DAG. It assigns higher visual importance to actions with different types or parameters among its neighbors while penalizing those with similar or identical actions, such as repetitive strokes commonly seen in digital sketching. More specifically, if act(n) and act(m) are of different types or parameters, then A(n,m)=10 d, where d is the distance between n and m in the DAG; otherwise, A(n,m)=1. A(n,m) is actually a very flexible term and can be fine-tuned to fit user requirements. By combining the low-level I(n,m) with the high-level A(n,m), the system already provides satisfactory results. After assigning visual importance values to all nodes, the DAG is traversed in the DFS order and accumulates the visual importance values. Once the accumulated value is higher than the threshold value of current resolution, the corresponding nodes in the DAG are clustered into a single RevG node. After the node clustering, the graph edges are added back.

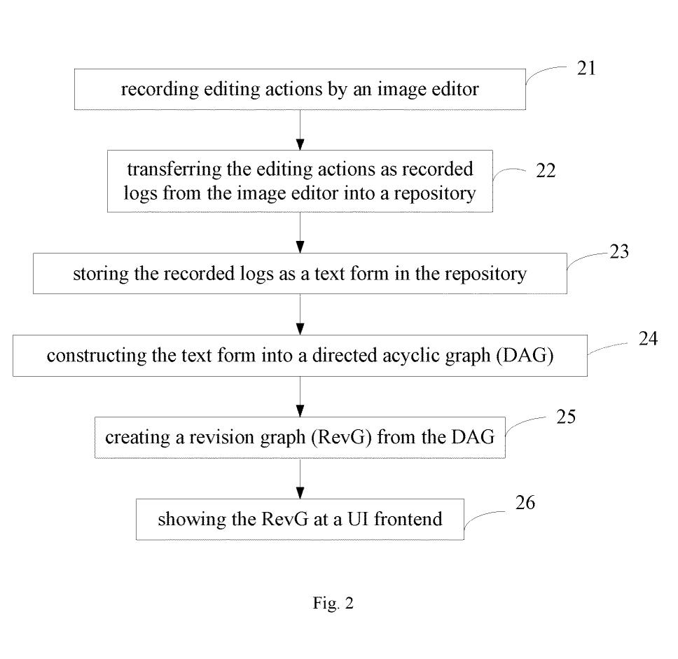

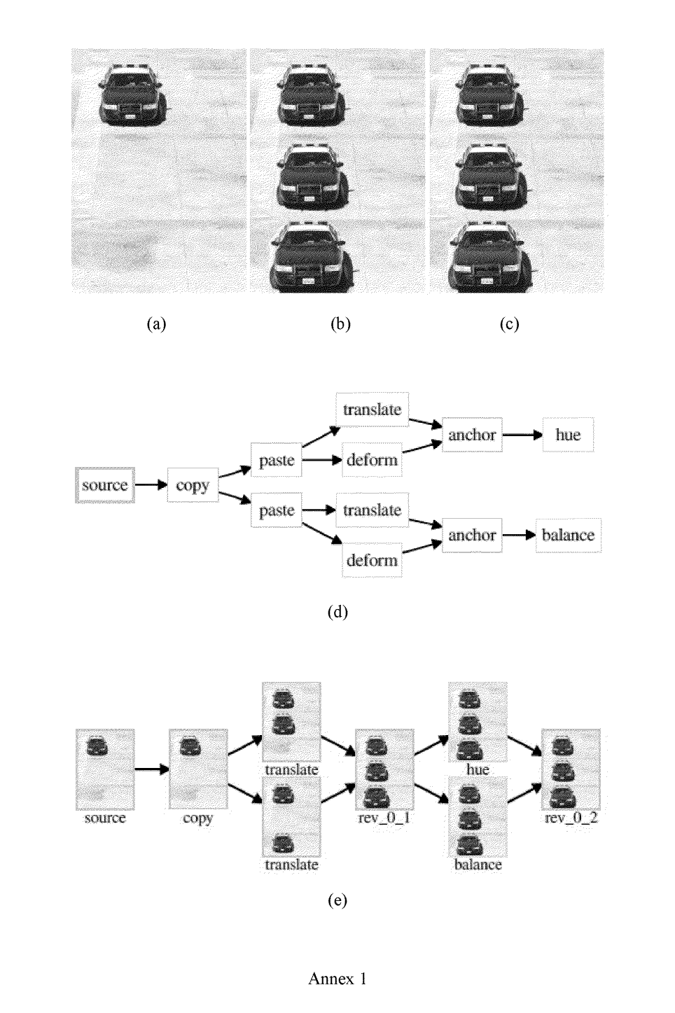

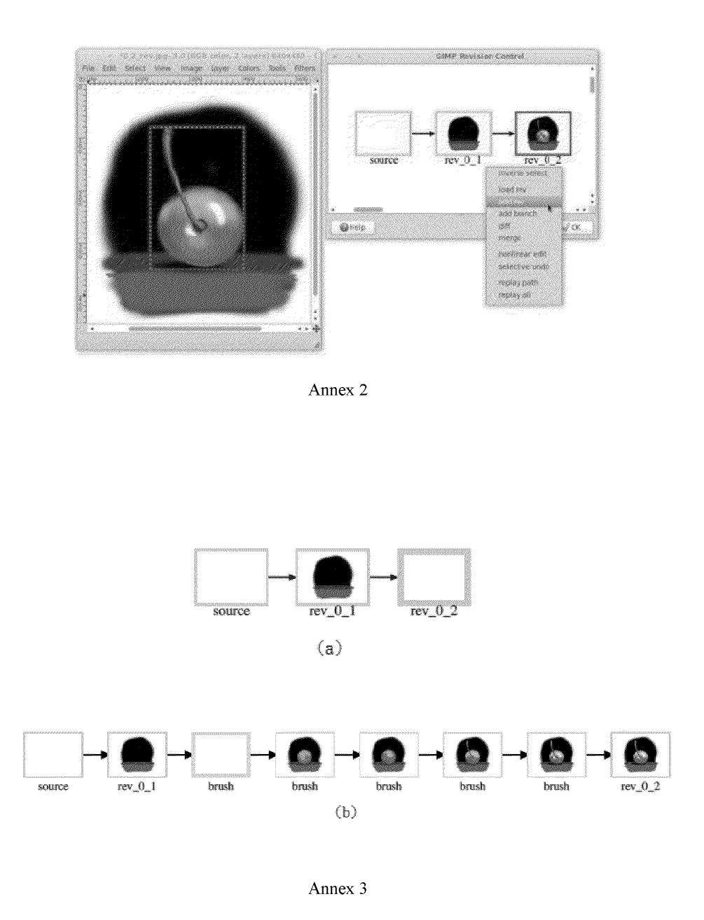

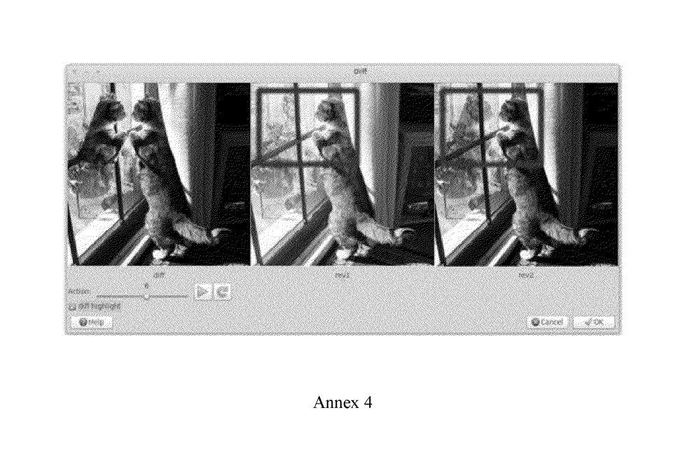

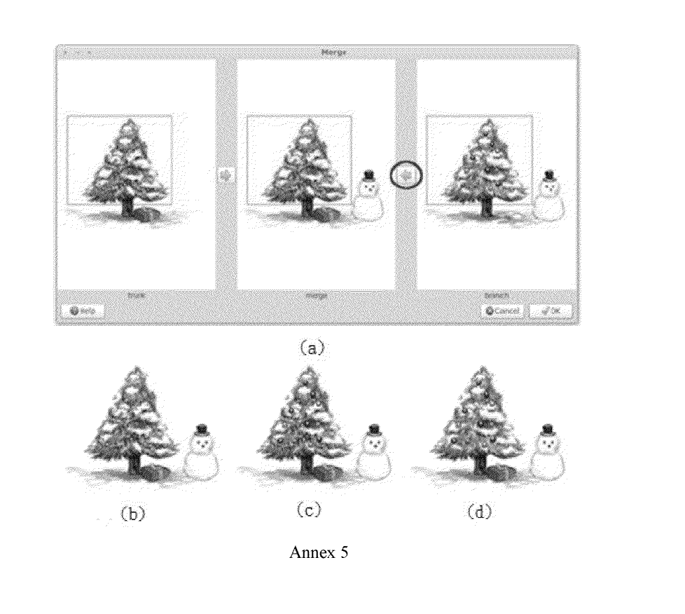

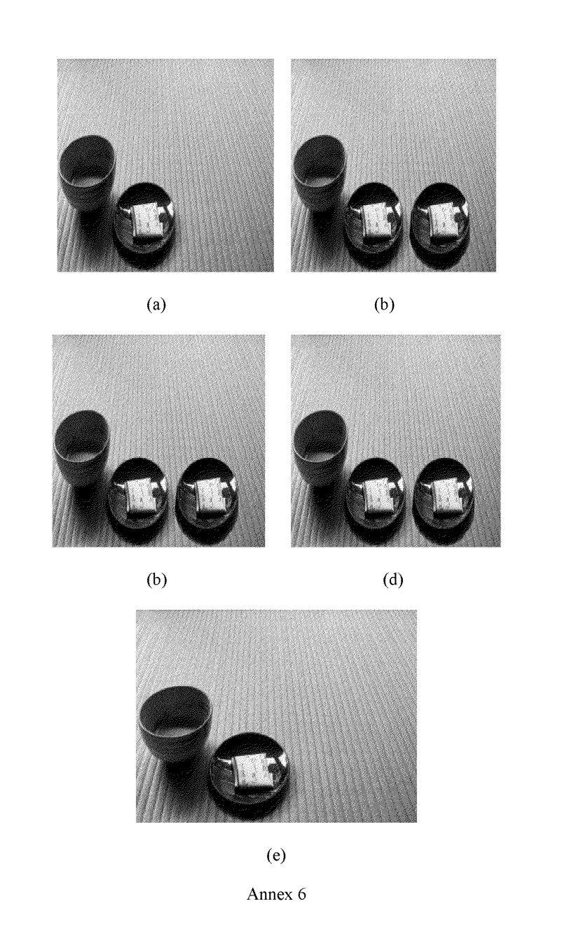

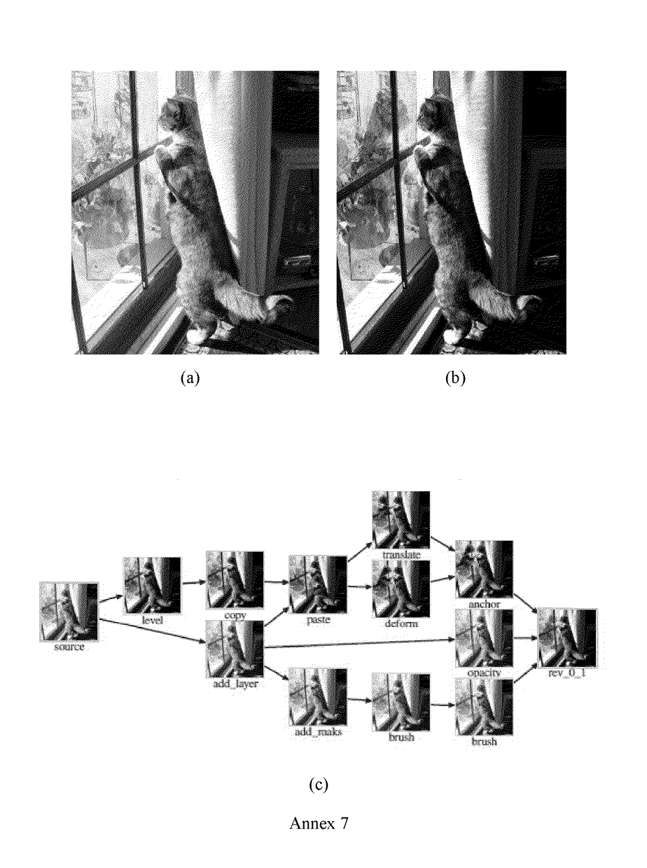

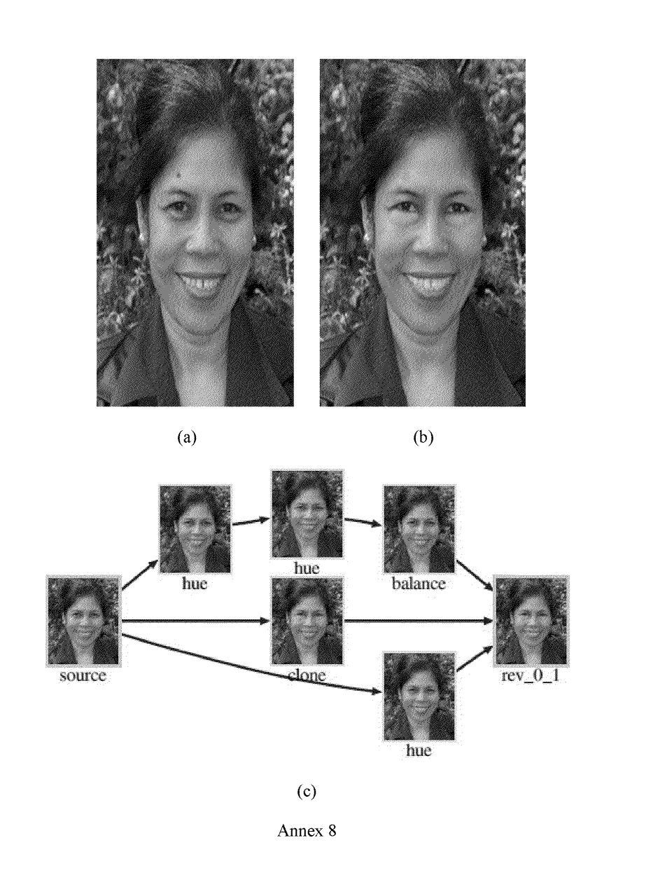

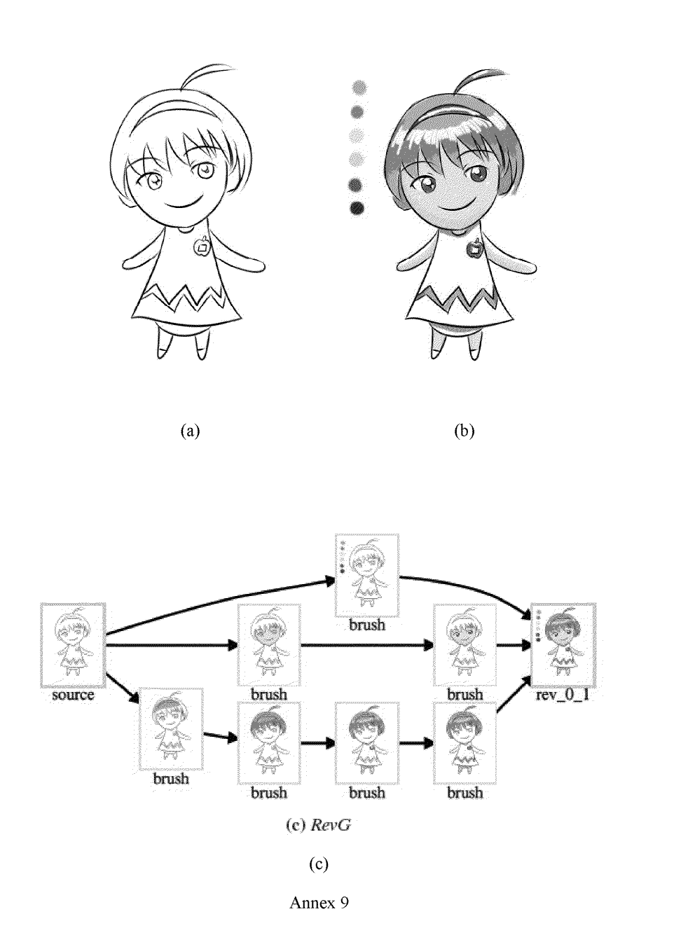

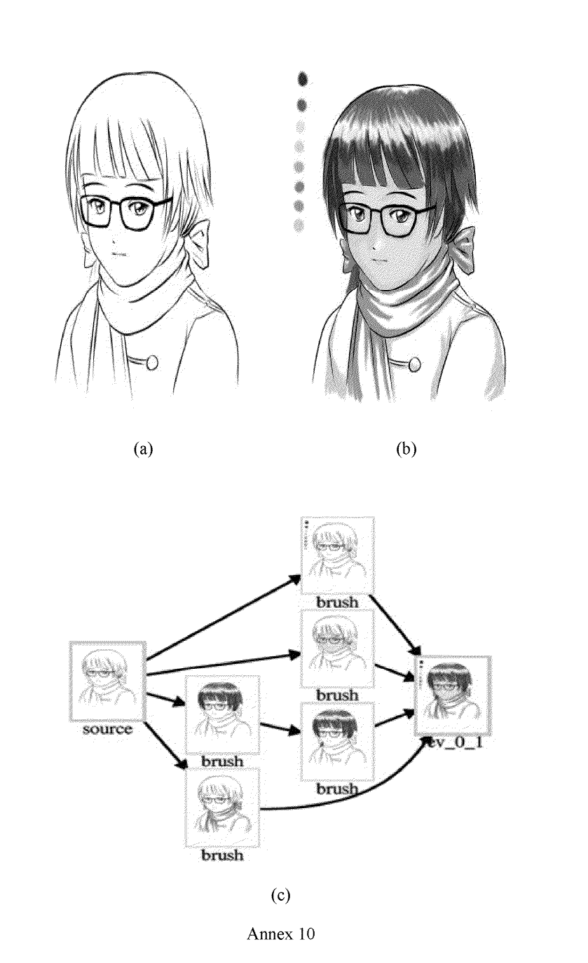

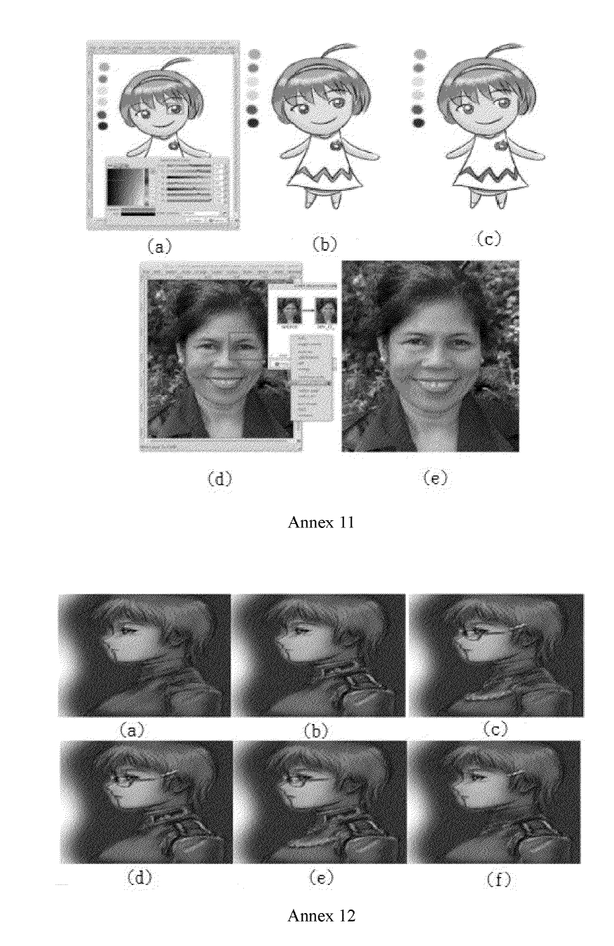

Please refer to FIG. 2, which is a system flow diagram of the invention, including the steps of: (a) recording editing actions by an image editor 21; (b) transferring the editing actions as recorded logs from the image editor into a repository 22; (c) storing the recorded logs as a text form in the repository 23; (d) constructing the text form into a DAG 24; (e) creating a RevG from the DAG 25; and (f) showing the RevG at a UI frontend 26. Step 25 further includes the steps: (e1) dynamically simplifying the DAG into the RevG for proper display; (e2) determining a position, path, shape and color of the nodes of the RevG via a classical hierarchical layout algorithm; and (e3) culling the nodes and edges of the RevG outside a current viewport, wherein the step (e1) further includes the steps: (e11) assigning a visual importance value to each node of the DAG; and (e12) filtering the DAG into the RevG according to a threshold assigned to a current RevG window resolution.

Please refer to Annex 1, which is a diagram showing an embodiment of a nonlinear revision control of the present invention, wherein: (a) is the input image (shown as a car); (b) is the input image, the car, to be cloned twice with translation and perspective deformation; (c) is to modify their colors; (d) is the revision control system to be recorded, and analyzing the actions into a DAG data structure, which represents an action-based revision history. A DAG is composed of nodes and directed edges. DAG nodes represent image editing operations with relevant information including types, parameters and applied regions. DAG edges represent the relationships between the operations. A (directed) sequential path between two nodes implies a spatial and/or semantic dependency and the path direction implies their temporal order. In contrast, multiple parallel paths between two nodes imply independent operation sequences, e.g. those that apply on disjoint regions or incur orthogonal semantics. The DAG faithfully records the user editing operations and gradually grows as more revisions are committed. Each revision in this system is a sub-graph of the DAG containing the root node which represents the act of initialization, i.e. opening an empty canvas or loading an existing image. The state of the revision is always equivalent to the result generated by traversing its corresponding sub-graph. Note that when dealing with image data, many modern state-based revision control systems (e.g. GIT, SVN and CVS) store separate images as revisions. While in the system, the DAG encodes only actions, not whole images. (e) is a graphical RevG for visualizing the DAG. Users can interact with RevG and perform revision control functions. Node border colors denote the action types (as shown in Table 1) and paths delineate the action dependencies. In particular, parallel paths indicate operations that are semantically (e.g. translation and deformation) or spatially (e.g. coloring two individual cars) independent. Due to the potentially high complexity and large size of DAG, this will not be directly exposed to ordinary users. Instead, the DAG is visualized via a state-based RevG. Each RevG is essentially a multi-resolution graph visualization of the DAG which is the highest resolution of the revision history. Specifically, each RevG node is the aggregation of one or more DAG nodes and RevG edges are the corresponding DAG edges after graph simplification. However, unlike the DAG, which is an abstract representation, each RevG node is visualized with a thumbnail according to the DAG actions.

Please refer to Annex 2, which is a diagram showing the revision control user interface of an embodiment of the present invention. Users can perform revision control functions via the right-click menu within the revision control window (right), which also visualizes the revision history through RevG. When a RevG node is selected, its corresponding spatial context will be highlighted via a bounding box in the main GIMP window (left). The RevG presents both revision branching and operation dependency in a unified representation. In particular, even for a linear revision history, the RevG can still exhibit non-linear parallel structures due to spatial or semantic independencies between operations, such as the editing example in FIG. 1. Through RevG, users can easily navigate at different resolutions as well as perform all revision control functions such as addition, diff, branching, merging, and conflict resolving.

Please refer to Annex 3, which is a diagram showing the multi resolution RevG of an embodiment of the present invention, wherein (a) is a coarser resolution and (b) is finer resolution. The system automatically displays the RevG in proper resolution depending on the viewing conditions and user preferences. In order to accommodate potentially complex revision history, RevG provides a multi-resolution view. Users can continuously navigate between different levels of detail, from the coarse revision resolution (a) to fine action resolution (b), as well as use the constrained navigation mechanism to focus on specific subsets of actions. Thus, users can directly interact with to obtain visual clues about the involved editing operations.

Please refer to Annex 4, which is a diagram showing a diff UI of an embodiment of the present invention. The preview window (left) shows the editing process between two revisions (middle & right). Users can manually drag the slider for a particular state or click on the play button for automatic playback. The refresh button would flicker between the two revisions for quick comparison.

In this embodiment, two revision diff visual mechanisms have been designed. The first one is the RevG itself (as shown in Annex 3), which users can directly interact with to obtain visual clues about the involved editing operations. Users can also turn on the bounding box of difference regions (e.g. the cat reflection). The second is a standalone diff UI that can be triggered by selecting two RevG nodes (as shown in Annex 4). The diff UI provides a side-by-side parallel comparison between revisions as well as sequential replay of the in-between actions.

Please refer to Annex 5, which is a diagram showing UI for revision merging of an embodiment of the present invention, wherein: (a) shows the merge UI. Images at left and right are revisions to be merged while the center is the preview of the merge result. (b) is the automatic merge result. Non-conflict edits (gift and snowman) are automatically merged while for conflict ones (ornamental strips and balls) the trunk version is chosen by default. The system also allows users to change the default behavior, including branch-after-trunk; (c) by clicking the blue circled button once, branch-only (d) by clicking the blue circled button twice, and trunk-after-branch.

Please refer to Annex 6, which is a diagram showing another merge embodiment, wherein: (e) is the source image, and (a) to (d) show different combinations of trunk and branch results. Therefore, four combination modes are created as (a) trunk only (coloring), (b) branch only (cloning) (c) trunk after branch and (d) branch after trunk.

Please refer to Annex 7, which is a diagram showing an image compositing embodiment, wherein: (a) is the image before compositing, (b) is the image after compositing and (c) is a RevG at the finest resolution. A fake reflection of the cat is created to enhance the richness of the photograph. Gamma adjustment is first applied followed by the copy and paste procedures. An additional layer mask is also used to correct the occlusion between reflection and window.

Please refer to Annex 8, which is a diagram showing an image retouching embodiment, wherein: (a) is the image before retouching, (b) is the image after retouching and (c) is a RevG at the finest resolution. Several popular image retouching techniques are applied in this example, including clone brush and hue/balance adjustment for eye sharpening, eye whitening, eye bag removal, and teeth whitening.

Annex 7 and Annex 8 are two practical image editing examples where many popular image compositing and photo retouching techniques were used. From the embedded thumbnail images and underlying text labels in the RevG nodes, users can clearly identify the involved operations and their dependencies. With RevG, users can easily review their own work or learn from others. The RevGs shows these two figures at different levels of detail to demonstrate the multi-resolution feature of the representation.

Please refer to Annex 9, which is a diagram showing a digital sketching embodiment, wherein: (a) is a sketch, (b) is a final image and (c) is a RevG at the finest resolution. The artist performed 649 brush strokes and employed three layers for the color palette, face, hair, and body. Note that the visual importance filter clusters operations with similar parameters (e.g. brush color) together.

Please refer to Annex 10, which is a diagram showing another digital sketching embodiment, wherein: (a) is a sketch, (b) is a final image and (c) is a RevG at the finest resolution. The artist employed 1391 operations and four layers for the palette, face, hair, and clothing.

Annex 9 and Annex 10 are two digital sketching examples produced by the collaborating professional artist. Each example consists of about one thousand actions, which exceeds the maximum size of state-based undo history stack of GIMP. The system faithfully recorded all actions and can reproduce the whole digital sketching session. As shown in the Annexes, the RevGs provide a compact and informative visualization of the sketching history by laying out independent operations in parallel paths and clustering together actions with similar parameters.

Please refer to Annex 11, which is a diagram showing nonlinear exploration. Given a rough selection region (a), the system would search for the related editing operations and adjust their parameters as intended (b). It also provides an intuitive nonlinear selective undo function where users can select any region on the image and undo the associated operations. (c) shows a possible variation created via this function. In (d), the operations applied on one eye without affecting other regions are undone, which is difficult to achieve with a linear history stack provided by most image editing systems. Finally, the system also provides selective replay where users can nonlinearly replay operations corresponding to specific regions of interest. That is, the selective undo operation can be easily achieved for side-by-side comparison or non-linear editing (e).

Please refer to Annex 12, which is a diagram showing a revision merge as a creativity support tool. From the input branch point (a), the artist created two different branches in (b) and (c). Based on these three images (a), (b) and (c), the artist then created three design variations (d), (e) and (f) using the merge UI. Note that only one layer is used for all operations.

Please refer to the following Table 2, which shows the storage size comparison and all sizes are expressed in K-bytes. The storage consumption of the present invention is particularly small compared to other image editing and revision control systems, such as GIMP (.xcf file), SVN, and GIT, as shown in Table 2. For all figures, the whole editing process is divided into four revisions, and committed to the revision repository. The storage overhead of the system of the present invention mainly comes from the cached thumbnail images. The overhead of internal data structures for GIT and SVN are not precisely calculated here, but the advantage of the present invention on storage size is clear.

TABLE 2

| | | | | | | The present |
|---|---|---|---|---|---|---|
| | input | # op | GIMP | SVN | GIT | invention |
| Annex 1 | 502 | 11 | 2.7K | 2.1K | 2.0K | 640 |
| Annex 3 | 1.6 | 672 | 267 | 224 | 180 | 73 |
| Annex 7 | 945 | 11 | 3.5K | 3.7K | 3.6K | 1.3K |
| Annex 8 | 276 | 10 | 972 | 1.2K | 1.2K | 420 |
| Annex 9 | 377 | 649 | 2.3K | 2.4K | 2.5K | 652 |
| Annex 10 | 425 | 1391 | 2.5K | 2.7K | 2.7K | 775 |

In summary, the present invention indicates that the system is indeed easy (and sometimes fun) to use, and helpful for revision control image editing projects, even though it might take some time and practice to learn. For execution tasks (e.g. revision control during image editing) the participants mostly stick to a single RevG resolution, while for cognition tasks (e.g. reviewing or exploring) they find the multi-resolution RevG informative. They also comment that the nonlinear revision history is very helpful in depicting editing information, especially for potentially complex layer structures. In addition to core revision control, participants also find the system conducive for their creative processes. Therefore, this present invention is not only convenient for graphics applications that use a significant amount of binary data, such as images, videos, meshes, and animations, but also saves the storage consumption, which fully satisfies the demands of the market.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A nonlinear revision control system for images, the system comprising:
a frontend used as an external user interface;
a backend coupled to the frontend, wherein the backend further comprises:
a repository for storing recorded logs and revision control information derived from user editing actions;
a first data structure for analyzing and transforming the logs from the repository;
a plurality of filters for simplifying the logs from the first data structure; and
a second data structure for storing the simplified logs from the plurality of filters and being rendered in the frontend; and
an image editor communicated with and applied for the backend.

2. The nonlinear revision control system for images of claim 1, wherein the first data structure is a DAG having nodes and edges, the DAG nodes representing editing operations, and the DAG edges representing corresponding nonlinear spatial, temporal and semantic relationships between recorded image editing operations.

3. The nonlinear revision control system for images of claim 1, wherein the second data structure is a revision graph (RegV) having nodes and edges, which provides not only a meaningful display of a revision history, but also an intuitive interface for common revision control operations such as review, replay, diff, addition, branching, merging, and conflict resolving.

4. The nonlinear revision control system for images of claim 1, wherein the frontend is a renderer selected from the group consisting of: GTK, Linux, Windows and related Operational system.

5. The nonlinear revision control system for images of claim 1, wherein the plurality of filters comprise:
a visual importance filter coupled to the first data structure, to dynamically simplify the DAG into the RevG for proper display;
a layout filter coupled to the visual importance filter, for determining a position, path, shape and color of the nodes of the RevG via a classical hierarchical layout algorithm; and
a viewport filter coupled to the second data structure, for culling the nodes and edges of the RevG outside a current viewport.

6. The nonlinear revision control system for images of claim 1, wherein the image editor is one selected from the group consisting of: GIMP (GNU Image Manipulation Program), Photoshop and related image editing program, the image editor further comprising:
a logger for recording the user editing actions; and
a replayer for replaying the user editing actions.

7. A nonlinear revision control method for images, the method comprising the steps of:
(a) recording editing actions by an image editor;
(b) transferring the editing actions as recorded logs from the image editor into a repository;
(c) storing the recorded logs as a text form in the repository;
(d) constructing the text form into a DAG;
(e) creating a RevG from the DAG; and
(f) showing the RevG at a UI frontend.

8. The nonlinear revision control method for images of claim 7, wherein the DAG and the RevG respectively have nodes and edges.

9. The nonlinear revision control method for images of claim 8, wherein the DAG nodes represent editing operations, and the DAG edges represent corresponding nonlinear spatial, temporal and semantic relationships between recorded image editing operations.

10. The nonlinear revision control method for images of claim 7, wherein the nodes and edges of the RegV provide not only a meaningful display of a revision history, but also an intuitive interface for common revision control operations such as review, replay, diff, addition, branching, merging, and conflict resolving.

11. The nonlinear revision control method for images of claim 7, wherein step (e) further comprises the following steps:
(e1) dynamically simplifying the DAG into the RevG for proper display;
(e2) determining a position, path, shape and color of the nodes of the RevG via a classical hierarchical layout algorithm; and
(e3) culling the nodes and edges of the RevG outside a current viewport.

12. The nonlinear revision control method for images of claim 11, wherein step (e1) further comprises the following steps:
(e11) assigning a visual importance value to each node of the DAG; and
(e12) filtering the DAG into the RevG according to a threshold assigned to a current RevG window resolution.
